(19) United States
(12) Patent Application Publication
(10) Pub. No.: US 2026/0035229 A1
(43) Pub. Date: Feb. 5, 2026

(54) An Apparatus for Dispensing an Additive into a Beverage

(71) Applicant: HODGES & DRAKE DESIGN LTD, Leicester, Leicestershire (GB)

(72) Inventors: Kevin Neville HODGES, Leicester (GB); Daniel LONGMAN, Leicester (GB)

(21) Appl. No.: 18/996,033

(22) PCT Filed: Jul. 5, 2023
(86) PCT No.: PCT/GB2023/051764

§ 371 Date: Jan. 17, 2025

(30) Foreign Application Priority Data
Jul. 20, 2022 (GB) 2210625.6

(51) Int. Cl. B67D 1/00

(52) U.S. Cl. CPC B67D 1/0021; B67D 1/0078

(57) ABSTRACT

The present invention provides an apparatus for dispensing an additive into a beverage including a supply line and a handle. The handle includes an additive dispenser having an additive reservoir and an additive outlet arranged to dispense additive into the beverage container; and an actuator for operating the additive container to dispense a known dose of additive from the additive reservoir out of the additive outlet. The handle can replace conventional beverage dispensing handles, such as beer taps, in order to allow additives to be dispensed into beverages.

### FIELD OF THE INVENTION

The present disclosure relates generally to an apparatus for dispensing an additive into a beverage. Embodiments of the present disclosure relate to an apparatus for adding an additive to a beverage dispensed from a counter top mounted beverage dispenser, for example beers, ciders, or soft drinks.

### BACKGROUND

In hospitality venues, such as public houses, bars and restaurants, beverages are often dispensed to a user from a beverage dispensing apparatus mounted on a counter or bar, such apparatus include traditional beer fonts as well as more modern button or switch operated beverage dispensers. In modern establishments a huge variety of beverages are dispensed from beverage dispensers including, but not limited to, beers, ciders, soft drinks, pre-mixed drinks, cocktails, wines, and water.

Generally, beverage dispensing apparatus are used to serve beverages from large containers such as kegs and barrels or with certain non-alcoholic beverage systems, mains water and pumped syrups are supplied. Carbon dioxide or nitrogen gas can be added to a beverage or used for pressurising the systems and preservation of the beverages. An advantage that such apparatus offer is that when the beverage is stored in large containers, such as kegs or barrels, the beverage can be transported and stored in one place and when the container is emptied, it can be returned to the supplier to be reused. Due to the bulk handling nature of this solution, beverage costs are lower than beverages stored in bottles.

It is becoming increasingly common to mix beverages dispensed from beverage dispensing apparatus with additives. Additives added to such beverages include, but are not limited to botanicals, flavours, sweeteners and CBD oils. Generally, these are supplied to a retailer in pre-mixed forms. However, some retailers will mix beverages with additives and there are some existing dispensing solutions that act to mix beverages with additives. Some additives are produced in concentrated forms that can be added to beverages in small doses ranging from 10 ml to micro-doses of 1 ml or less.

Some additives are commonly used with particular beverages. For example, a specific flavouring may be commonly used with a specific beer and you may be offered that beer with or without that specific flavouring when ordering.

There is a desire for apparatus that act to add additives to beverages at the point of dispensing on the request of a consumer. Preferably any such apparatus are compact, simple to use, and do not require replacement of existing beverage dispensing apparatus.

### SUMMARY OF THE INVENTION

The present invention provides an apparatus for dispensing an additive into a beverage comprising:
a supply line formed between a beverage inlet and a beverage outlet configured to dispense beverage into a beverage container;
a handle mounted on the supply line, immediately above the beverage outlet;
the handle being operable to dispense beverage into a beverage container from the beverage outlet; characterised in that:
the handle comprises:
an additive dispenser having an additive reservoir and an additive outlet arranged to dispense additive into the beverage container; and
an actuator for operating the additive container to dispense a known dose of additive from the additive reservoir out of the additive outlet.

The apparatus of the present invention is advantageous in that it provides a simple and compact apparatus for adding additives to beverages at the point of dispensing. In particular, the handle of the apparatus is purposed to contain and dispense an additive into a beverage. A suitable additive is contained in the additive reservoir of the handle and can be dispensed into a beverage by operating the actuator to dispense an additive into the beverage container.

The apparatus may be operated as follows. The handle may be operated in a conventional manner to dispense a beverage from the beverage supply line into a beverage container positioned in an appropriate position relative to the beverage outlet. If it is desired to dispense an additive into the beverage container the actuator of the handle is operated to dispense a known dose of additive into the beverage container. The additive may be able to be dispensed at the same time as the beverage is dispensed and/or before and/or after the beverage is dispensed.

The handle may be sized and shaped to conform to the size of a conventional beverage dispensing handle, for example the handle may conform to the shape of the handle of a traditional beer pump. Alternatively the handle may be any other suitable size and shape such that it can contain a suitable amount of additive in the additive reservoir.

Advantageously the additive used with the present invention will be an additive that can be added to a beverage in small doses ranging from 10 ml to micro-doses of 1 ml or less, such that an additive reservoir of the present invention may contain multiple doses of the additive. In embodiments of the invention the additive reservoir may contain more than 5, more than 10, more than 20, more than 50, or more than 100 micro-doses of an additive.

### Removable Handle Replaceable Additive Container

The supply line may be the supply line of an existing beverage dispensing system, such as a beer pump, cider pump, or a soft drink dispensing system. The supply line may be a supply line extending from a bulk beverage supply, such as a beer keg, to a counter mounted dispensing apparatus.

The apparatus of the present invention may be mounted on a bar, counter, table or other suitable support to allow beverages to be dispensed easily. For example, the apparatus is particularly suitable for being mounted on bars in the same manner as conventional beer pumps.

The additive outlet of the present invention may be formed and positioned in any suitable manner that allows additive dispensed from the additive reservoir to be dispensed into a beverage. When the actuator is operated a volume of additive will be dispensed from the additive reservoir, via the additive line, into a beverage positioned below the beverage outlet and additive outlet. This may be done before or after dispensing a beverage or during dispensing of a beverage.

In embodiments of the invention the additive outlet may be located adjacent the beverage outlet and be arranged to dispense additive directly into the beverage container when the actuator is operated. For example, the handle may comprise an additive line extending from the additive reservoir to the additive outlet such that the additive outlet is positioned adjacent the beverage outlet.

In alternative embodiments of the invention the additive outlet may be located in the beverage supply line and be arranged to dispense additive into the supply line adjacent the beverage outlet. For example, the handle may comprise an additive line extending from the additive reservoir to the additive outlet that is formed in the supply line. In such embodiments when the actuator is operated additive will be dispensed from the additive outlet into the supply line, out of the beverage outlet and into a beverage. In such embodiments an air outlet may be provided in the supply line adjacent the beverage outlet. This is advantageous as it can ensure that additives dispensed from the additive reservoir flow freely out of the supply line and are not retained in the supply line by air pressure. It is anticipated that the skilled person will understand how and where an air outlet may be provided in a supply line to ensure free dispensing of an additive without additive or beverage escaping from the air outlet during operation of the apparatus. For example an air outlet may be provided in the supply line before the additive outlet and/or at least an initial portion of an air outlet may be angled upwards such that liquid will not easily exit the apparatus via the air outlet.

In embodiments of the invention the actuator may be a trigger that acts to dispense a known dose of additive when operated. A trigger may be formed in any manner apparent to a person skilled in the art. One construction of a trigger is shown in the drawings and discussed below. The dose dispensed by the trigger is advantageously a constant amount such that each time the trigger is operated the same dose of additive is dispensed by the apparatus.

A trigger may be formed such that it functions on a return stroke. In such embodiments it is required that a trigger is fully depressed to dispense a dose of additive. This may be advantageous as it would prevent dispensing of partial doses, for example when a trigger is only partially depressed.

In embodiments of the invention wherein the actuator is a trigger and the supply line is a beer or cider supply line the apparatus may be formed such that a single full depression of the trigger dispenses the appropriate amount of additive for half a pint (284 ml) of beverage whilst two full depressions of the trigger will dispense the appropriate amount of additive for a full pint (568 ml) of beverage.

The additive dispenser of the present invention may be permanently formed within the handle or may be removably mounted within the handle. If the additive dispenser is permanently mounted it is preferable that an opening for refilling the additive dispenser is provided. If the additive dispenser is removably mounted it may be preferable that the handle comprises a housing formed to contain a removable additive dispenser. The handle may completely enclose the additive dispenser and comprise an openable closure, such as a door, that allows an additive dispenser to be inserted into and removed from the handle. Alternatively, the handle may partially enclose the additive dispenser to allow an additive dispenser to be added into and removed from the handle without requiring opening and closing of a closer.

The additive dispenser may be formed in any manner apparent to a person skilled in the art. Advantageously the additive dispenser and the actuator may be mechanical (i.e. powered entirely by the operation of the actuator by the user) and not require a power source to operate. This is advantageous as it means that it is not necessary to provide a power supply to the handle. However, in alternative embodiments the actuator and/or the additive dispenser may be operated by a motor or other powered actuating means and power supply for the handle may be provided.

If the actuator is mechanical the additive dispenser may be formed as a syringe having a plunger such that operating the actuator acts to depress the plunger into the syringe. In such embodiments of the invention the plunger may be formed as a linear rack with teeth and operating the actuator may act on the teeth of the rack to depress the plunger. For example, the actuator may be a trigger that when depressed acts to move the rack of the plunger by a single tooth to dispense additive from the additive reservoir. As set out above, if the actuator is a trigger it may be formed to act on a return stroke, in such embodiments where the plunger is linear rack with teeth the return stroke of the trigger may act to move the plunger by a single tooth to dispense additive from the additive reservoir.

If the additive dispenser comprises a plunger having a linear rack with teeth it may be advantageous that the teeth of the linear rack are evenly spaced and the spacing of the teeth corresponds to a single dose of additive within the syringe.

The handle of the present invention may be formed to operate in any appropriate manner. In embodiments of the invention the handle may be a pivotable lever for dispensing beverage from the beverage outlet. That is, the handle may be formed to operate in the same manner as a handle on a conventional beer tap.

The handle of the present invention may be either permanently mounted to the apparatus or may be removable and replaceable. If the handle is removable it may be attached to the apparatus in any appropriate manner, for example it may be attached by means of a screw fitting, bayonet fitting, or any other suitable fitting. Such a fitting may be formed at a lower end of the handle or in any other suitable position.

Generally, apparatus according to the present invention will comprise a single additive dispenser. However, embodiments of the invention may comprise two, three, or more additive dispensers each containing a different additive and having an associated additive outlet and actuator. In such embodiments the apparatus may act to dispense two or more different additives into a beverage.

Further features of the invention will be apparent from the preferred embodiments shown in the Figures and described below. Unless otherwise indicated in the claims or the description any feature of the embodiments shown in the Figures may be included in any other embodiment of the invention independent from any other feature.

### DRAWINGS

FIG. 1 is an exploded view of a first embodiment of apparatus according to the present invention;

FIG. 2 is a diagram of the first embodiment with the handle cut-through to show its internal construction;

FIG. 3 comprises further views of the first embodiment;

FIG. 4 illustrates the operation of the first embodiment;

FIG. 5 illustrates the assembly of the first embodiment;

FIG. 6 illustrates the insertion of an additive dispenser into the handle of the first embodiment;

FIG. 7 is a perspective view of a disassembled additive dispenser of the first embodiment;

FIGS. 8 to 10 show the mechanism of operation of the actuator and additive dispenser of the first embodiment;

FIG. 11 shows three alternative constructions of apparatus according to the present invention; and

FIG. 12 shows embodiments of apparatus according to the present invention in position on a counter.

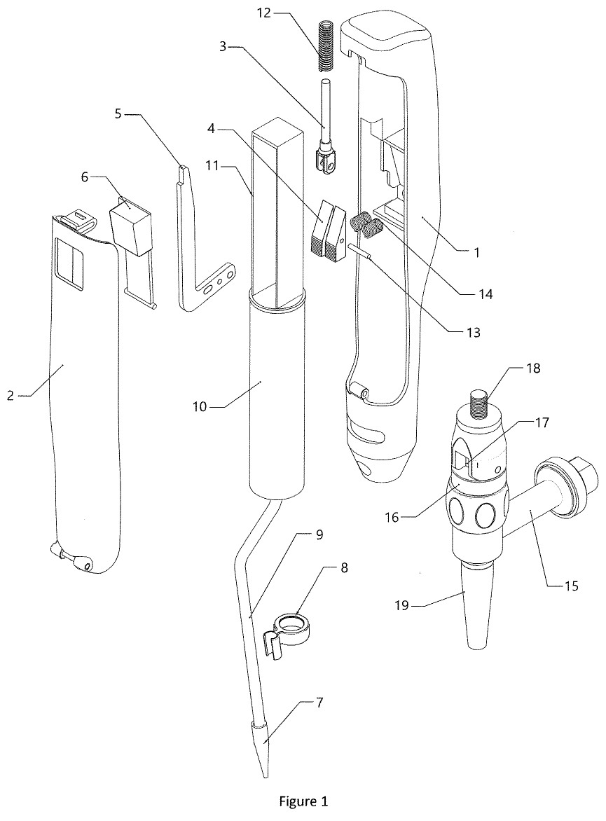

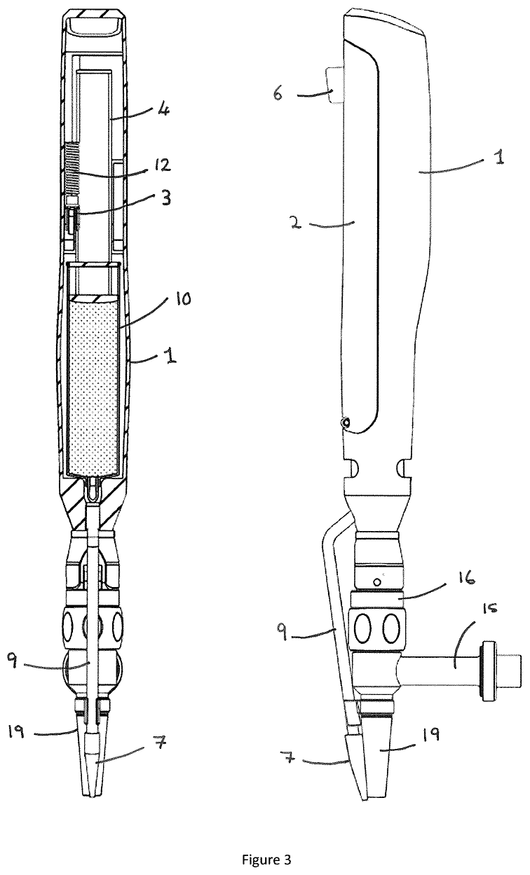

A first embodiment of an apparatus according to the present invention is shown in FIGS. 1 to 10. The components of the apparatus can be best seen in FIG. 1.

The apparatus comprises a handle 1 containing an additive dispenser 10. The additive dispenser 10 is formed as a syringe having a reservoir formed by the body of the syringe and having an additive line 9 extending from a lower end of the reservoir to an additive outlet 7. The additive line 9 is formed of a flexible polymer that allows it to be manipulated into an appropriate shape when inserted into and remove from the handle 1. The additive dispenser comprises a plunger 11 having a toothed rack. When the plunger 11 is depressed into the reservoir additive is dispensed from the additive outlet 7 via the additive line 9. Details of the additive dispenser are best shown in FIG. 7.

During use of the apparatus the additive dispenser 10 is contained within the handle 1 and can be accessed by means of an openable cover 2, which is attached to the body 1 by means of a hinge at a lower end. An actuator 6 is mounted to dispense additive from the additive dispenser 10. The actuator 6 comprises 1 trigger 6 that acts on a lever 5, and ratchet gears 4 to dispense additive in a manner described in further detail below.

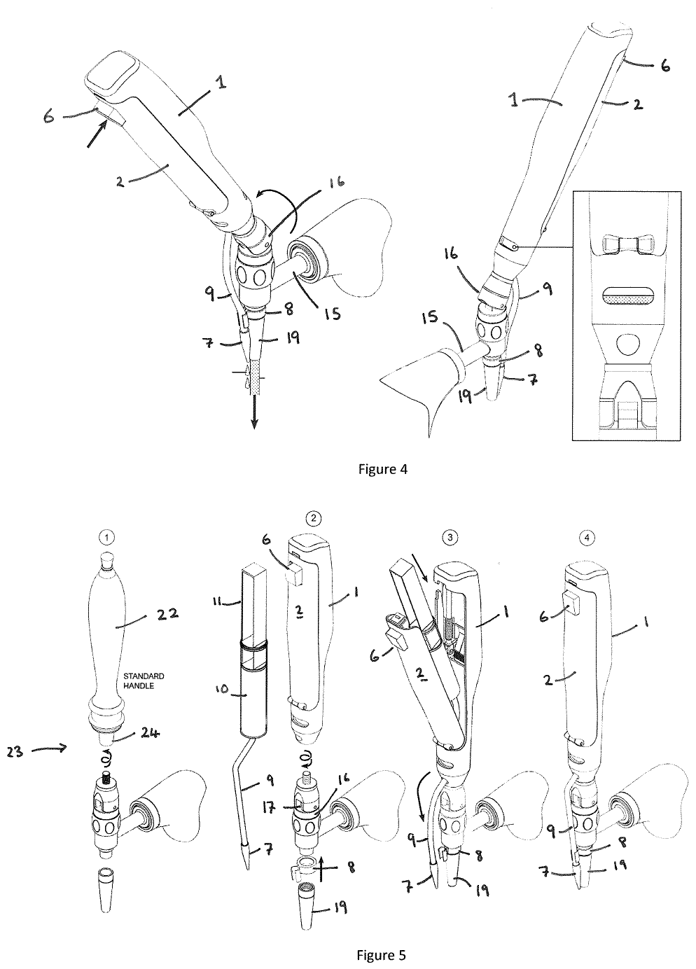

In use the handle 1 is mounted on a beverage pump 16 by means of a screw connection 18. The beverage pump 16 comprises a beverage supply line 15 having a nozzle 19 containing a beverage outlet. The beverage pump 16 is operating by pivoting the handle 2 about a hinged joint 17 to dispense beverage in a conventional manner, as shown in FIG. 4. In particular, when the handle 2 is pulled towards the user beverage is dispensed from the nozzle 19 into a beverage container positioned below the nozzle 19.

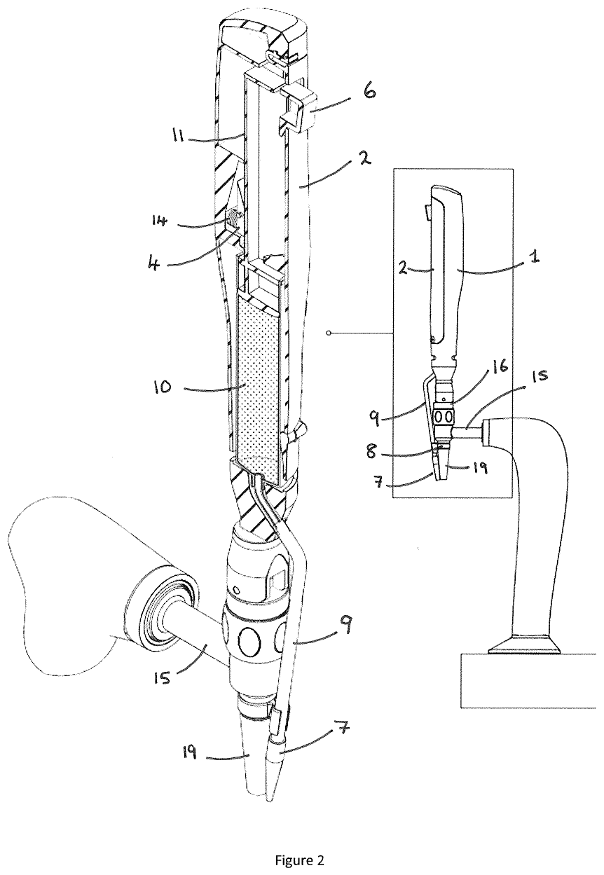

As shown in FIG. 2, the apparatus of the present invention may be mounted on a counter top 21 and resembles a conventional beer pump, as may be found in many bars and restaurants. In particular, as shown in FIG. 5 the apparatus of the present invention may be formed by replacing a standard handle 22 of a beer pump 23 with the handle 1 of the present invention. A standard handle 22 is attached to a beer pump 23 by a screw fitting 24 at a lower end. The handle 1 of the present invention is formed with an equivalent screw fitting to allow it to be screwed onto a beer pump 23 and replace the standard handle 22.

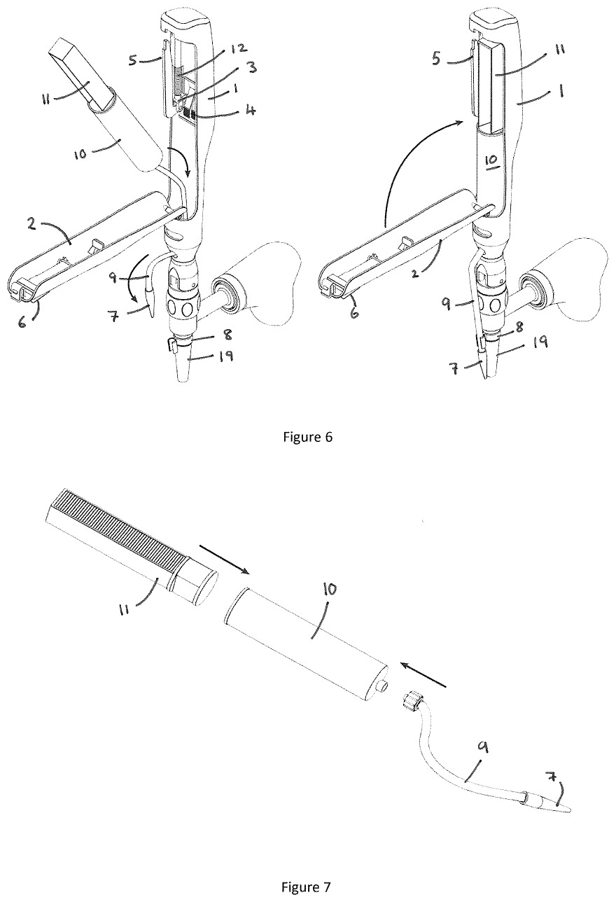

FIG. 6 shows how the additive dispenser is inserted into the handle 1 of the present invention. This may be done before or after the handle 1 is attached to the beer pump 23. The openable cover 2 is opened to expose the interior of the handle 1. The additive line 9 is threaded through an aperture 25 formed at a lower end of the handle 1 and the additive dispenser 10 is positioned within the handle 1. The cover 2 is then closed to contain the additive within the handle 1. This can be done before or after the handle 1 is attached to the beer pump 23. After the handle 1 is attached to the beer pump 23 the nozzle 19 of the pump is removed, an additive clip 8 is slid onto a beverage outlet of the beverage line 15 and the nozzle 19 is reattached below the clip 8. The additive line is then 9 fixed into position using the clip 9 such that the additive outlet 7 is positioned immediately adjacent an outlet of the nozzle 19, as shown, for example, in FIGS. 5 and 6. When the additive dispenser 10 is empty it can be replaced by reversing the method by which it was inserted.

When the handle 1 is positioned on the beer pump 23 beer can be dispensed from the beer pump by a user pulling the handle 1 towards themselves in a conventional manner. A beverage container (not shown) is positioned directly below the beverage nozzle 19 such that the beer is dispensed from the beer pump 23 into the beverage container. If it is desired to dispense an additive into the beverage container then the trigger 6 is fully depressed a dose of additive is then dispensed from the additive dispenser into the beverage container when the trigger is released. If two doses of additive are required then the trigger 6 is fully depressed and released twice. A window 26 is provided in an outer side of the handle 1. This window 26 is used to determine if the additive dispenser 10 is empty and needs replacing.

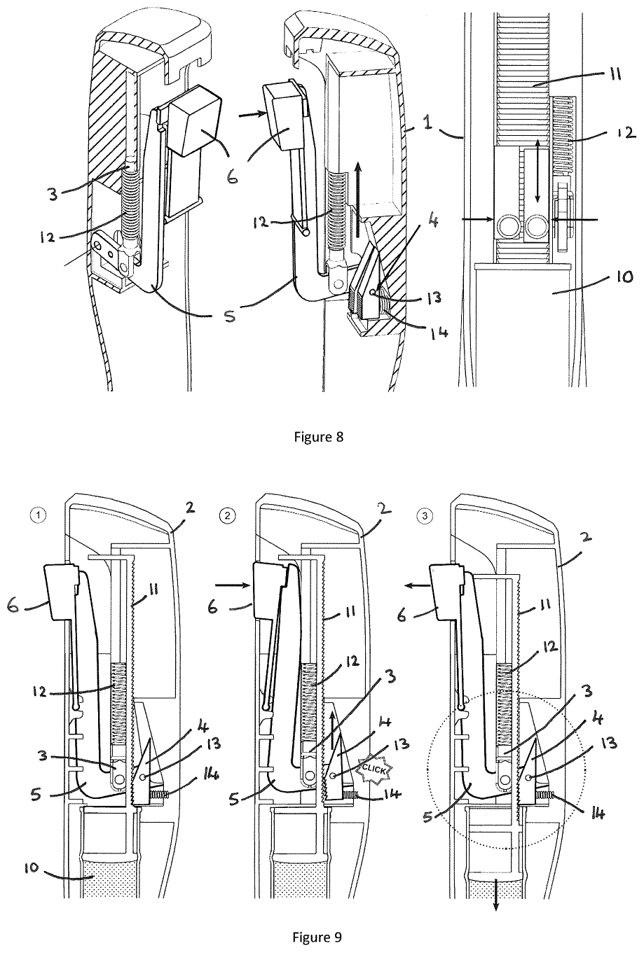

The operation of the trigger 6 to dispense a dose of additive is shown in FIGS. 8 to 10. The trigger 6 is mounted on an outer end of a vertically extending arm of an L-shaped lever 5. The lever 5 has a vertically extending part and a horizontally extending part. The lever 5 is pivotally mounted within the handle 1 adjacent an outer end of the horizontally extending arm. The lever 5 is sprung mounted and biased downwards within the handle 1 by means of a vertically extending arm 3 that is pivotally mounted at a lower end to the lever 5 and contained within an aperture formed in the handle 1 at an upper end. A spring 12 is provided between the lower end of the lever and the aperture in the handle 1 such that the vertically extending arm 3 is biased downwards. Two ratchet gears 4 are sprung mounted against a rear wall of the handle 1 by means of resilient springs 14 and are positioned horizontally adjacent to one another and to an outer end of the horizontally extending part of the lever 5. One of the ratchet gears 4 is a first ratchet gear, located adjacent the lever 5 and is pivotally mounted to the horizontally extending part of the lever 5 by means of an axle 13 extending through both the lever 5 and the lever adjacent ratchet gear 4. The axle 13 extends through the horizontally extending arm of the lever inwardly from the lever's pivotal mounting to the handle 1. The other of the ratchet gears 4 is a second ratchet gear 4, is not fixed to the lever 5, is horizontally biased towards the plunger 11, and is mounted such that it cannot move vertically. The plunger 11 has a toothed rack formed on an outer surface thereof. The toothed rack engages with the ratchet gears 4 when the additive dispenser is located within the handle 1. The teeth of the toothed rack and the ratchet gears 4 are formed such that when the ratchet gears 4 are engaged with the toothed rack the toothed rack cannot move upwards and the first ratchet gear 4 cannot move downwards.

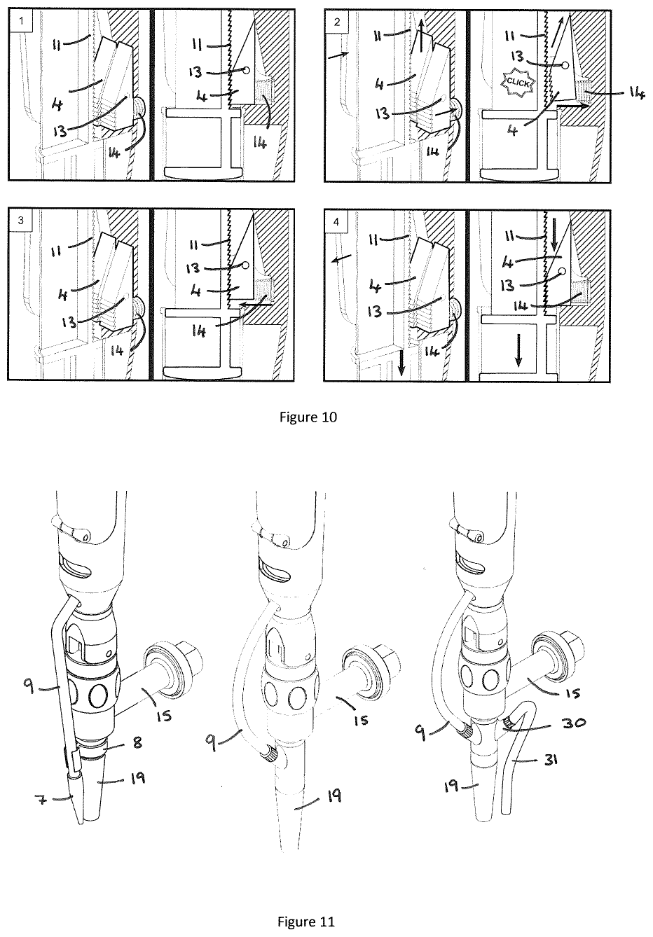

The operation of the trigger 6 is as follows. In a rest position the springs 14 push the ratchet gears 4 into engagement with the toothed rack of the plunger 11. The spring 12 acts on the vertically extending arm 3 to keep the trigger 6 pushed outwards. This is shown in box 1 of FIG. 10.

When the trigger 6 is depressed inwardly by a user, the lever 5 pivots about its pivotal mounting to the handle 1. This moves the vertically extending arm of the lever 5 upwardly against the action of the spring 12 and also acts to move the first ratchet gear 4 upwards. The second ratchet gear 4 is not moved. This first ratchet gear 4 is moved upwards one tooth of the tooth rack of the plunger 11 wherein the spring 14 acts to reengage the first ratchet gear with the toothed rack of the plunger 11. There will be an audible click when this happens indicating that the trigger 6 has been sufficiently depressed.

If the trigger 6 is only partially depressed the first ratchet gear 4 will be moved upwards by less than one tooth of the toothed rack of the plunger 11 and will not re-engage with the toothed rack. Instead it will move upwards by less than a tooth of the toothed rack and when the trigger is released the spring 12 will act to return the lever 5 to its original position and there will be no audible click. This will not act to dispense any additive from the additive dispenser 11. It is essential that the trigger 6 is fully depressed to dispense additive from the additive dispenser 10.

After the trigger 6 has been fully depressed the user will release the trigger. This will allow the spring 12 to move the lever 5 back to its original position. This also acts to push the first ratchet gear 4 downwards. As the first ratchet gear 4 is engaged with the toothed rack, this acts to move the toothed rack downwards and moves the plunger 11 downwards by a distance equal to the separation between the teeth of the toothed rack. This dispenses a dose of additive from the additive dispenser 10. As the plunger 11 is moved downwards under the action of the first ratchet gear 4 the second ratchet gear, which is not capable of vertical movement, is pushed inwards, and then re-engages the toothed rack when the toothed rack has moved downwards by one tooth. In this manner a dose of additive is dispensed when the trigger 6 has been fully depressed and then released.

If two or more doses are required to be dispensed from the additive dispenser then it is necessary to completely depress and release the trigger 6 the appropriate number of times. This prevents accidentally dispensing too much additive.

The spacing of the teeth of the ratchet gears 4 and the toothed rack of the plunger 11 determines the amount dispensed from the additive dispenser 10. This can be modified between specific embodiments of the invention such that more or less additive is dispensed with each depression of the trigger 6.

In the embodiment of the invention described above and shown in FIGS. 1 to 10, the additive line 9 and the additive outlet 7 are external to the nozzle. This is a simple construction that allows the handle 1 to be used with existing beverage fonts 23. This construction is shown as the left of the three embodiments of FIG. 11. Alternative embodiments are also shown in FIG. 11.

In the central embodiment of FIG. 11 the additive line 9 extends downwards to a point where it enters the beverage supply line 15 just above the nozzle 19. The additive line 9 can enter the beverage supply line 15 by means of a screw fitting or other removable fitting such that the additive line 9 can be detached when it is necessary to replace the additive dispenser 10. In this embodiment the additive is dispensed from the additive dispenser 10 directly into the beverage supply line 15.

In the right-hand embodiment of FIG. 11 the additive line attaches to the beverage supply line 15 in the same manner as the central embodiment. This embodiment additionally comprises an air vent 30 formed in the beverage supply line opposite the point at which the additive line 9 joins with the beverage supply line 15. An air vent line 31 extends outwards from the air vent, it extends upwards a short distance before extending downwardly parallel to the nozzle. The short upward extending portion ensures that liquid does not easily exit the beverage supply line 15 via the air vent line 31. The air vent 30 acts to ensure that no additive or beverage is retained in the nozzle 19 after dispensing. This can be particularly important for the dispensing of micro-dosing of additives whereby a small amount of liquid retained in the nozzle 19 can involve a significant proportion of the additive not being dispensed into a beverage.

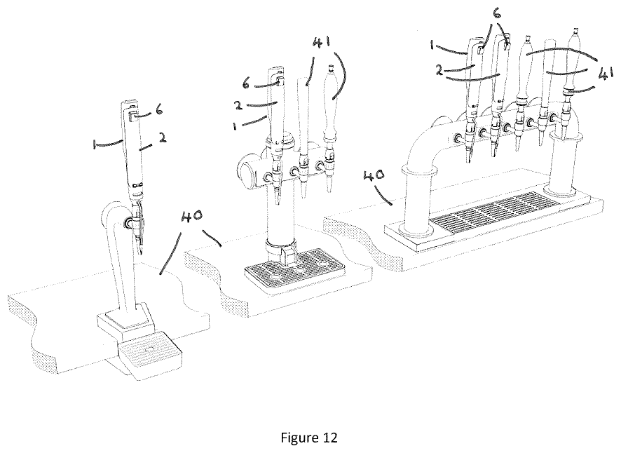

FIG. 12 shows embodiments of the invention in position on counter tops 40. As can be seen, the handle 1 can be mounted in place of any conventional drink dispensing handle 41. They can be positioned on their own, adjacent conventional drink dispensing handles 41, or adjacent additional handles 1 according to the present invention. That is, a handle 1 can replace a conventional dispensing handle 41 of any beverage dispenser usually found in a bar, pub, club, restaurant or other similar venue.

1. An apparatus for dispensing an additive into a beverage, comprising:
a supply line formed between a beverage inlet and a beverage outlet configured to dispense beverage into a beverage container;
a handle mounted on the supply line, immediately above the beverage outlet;
the handle being operable to dispense beverage into a container from the beverage outlet;
wherein:
the handle comprises:
an additive dispenser having an additive reservoir and an additive outlet arranged to dispense additive into the beverage container; and
an actuator for operating the additive container to dispense a known dose of additive from the additive reservoir out of the additive outlet.

2. The apparatus according to claim 1, wherein the additive outlet is located adjacent the beverage outlet and is arranged to dispense additive directly into the beverage container.

3. The apparatus according to claim 1, wherein the additive outlet is located in the supply line and is arranged to dispense additive into the supply line adjacent the beverage outlet.

4. The apparatus according to claim 3, wherein an air outlet is formed in the supply line adjacent the beverage outlet.

5. The apparatus according to claim 1, wherein the actuator is a trigger that acts to dispense a known dose of additive.

6. The apparatus according to claim 1, wherein the additive dispenser is removably mounted within the handle.

7. The apparatus according to claim 6, wherein the handle comprises a housing including an openable door.

8. The apparatus according to claim 1, wherein the additive dispenser is formed as a syringe having a plunger.

9. The apparatus according to claim 8, wherein the plunger of the syringe is formed as a linear rack with teeth and operating the actuator is formed such that when depressed it acts on the linear rack to depress the plunger.

10. The apparatus according to claim 9, wherein the actuator is formed as a trigger that acts to move the linear rack on a return stroke.

11. The apparatus according to claim 9, wherein the teeth of the linear rack are evenly spaced and correspond to a single dose of additive within the syringe.

12. The apparatus according to claim 1, wherein the handle is a pivotable lever for dispensing beverage from the beverage outlet.
